(19) United States
(12) Patent Application Publication
(10) Pub. No.: US 2026/0162308 A1
(43) Pub. Date: Jun. 11, 2026

(54) ENCODER, OPERATING METHOD OF THE ENCODER, AND IMAGE PROCESSING DEVICE

(71) Applicant: Samsung Electronics Co., Ltd., Suwon-si (KR)

(72) Inventors: WONJAE CHOI, Suwon-si (KR); JUNGYEOP YANG, Suwon-si (KR); JONGSEONG CHOI, Suwon-si (KR)

(21) Appl. No.: 19/289,023

(22) Filed: Aug. 2, 2025

(30) Foreign Application Priority Data
Dec. 9, 2024 (KR) 10-2024-0181969

(51) Int. Cl. G06T 9/00; G06T 3/40; G06T 7/00

(52) U.S. Cl. CPC G06T 9/00; G06T 3/40; G06T 7/00; G06T 2207/20016; G06T 2207/20076

(57) ABSTRACT

An embodiment provides an encoder comprising a block area transformation module configured to receive a processing unit block that is generated based on source data and includes a target block, and generate a plurality of multi-scale images having different sizes based on the processing unit block, each of the plurality of multi-scale images including the target block; a statistic calculation module configured to calculate feature values for each of the plurality of multi-scale images; a weight calculation module configured to calculate a weight corresponding to each of the plurality of multi-scale images based on the resolution of the source data output by the display; a complexity calculation module configured to calculate complexity for the source data based on feature values and weights corresponding to each of the plurality of multi-scale images; and a cost calculation module configured to generate compressed data for the source data based on the complexity.

### CROSS-REFERENCE TO RELATED APPLICATION

This application claims priority to and the benefit of Korean Patent Application No. 10-2024-0181969, filed on December 9, 2024, in the Korean Intellectual Property Office, the entire contents of which are incorporated herein by reference.

### BACKGROUND

### a Field

The present disclosure relates to an encoder, an operating method of the encoder, and an image processing device.

### b Description of the Related Art

Electronic devices such as smartphones, tablet PCs, laptop/desktop computers, and digital cameras may be equipped with digital video functionality. These electronic devices may transmit, receive, encode, decode, and/or store digital video information more efficiently by implementing video compression techniques. As demand for high-definition video increases, electronic devices must process large amounts of digital video information. Accordingly, the need for high-efficiency video compression technology is increasing.

Meanwhile, from a human perceptual and visual perspective, the size of the content output from the video information may vary depending on the resolution of the video output from the electronic device and the viewing distance from the electronic device. To address these issues, technologies are required that may compress images at different resolutions and viewing distances while maintaining visual quality.

### SUMMARY

The present disclosure provides an encoder for compressing images at various resolutions.

An embodiment of the present disclosure provides an encoder comprising a block area transformation module configured to receive a processing unit block that is generated based on source data and includes a target block, and generate a plurality of multi-scale images having different sizes based on the processing unit block, each of the plurality of multi-scale images including the target block; a statistic calculation module configured to calculate feature values for each of the plurality of multi-scale images; a weight calculation module configured to calculate a weight corresponding to each of the plurality of multi-scale images based on the resolution of the source data output by a display; a complexity calculation module configured to calculate complexity for the source data based on the feature values and the weights corresponding to each of the plurality of multi-scale images; and a cost calculation module configured to generate compressed data for the source data based on the complexity.

An embodiment of the present disclosure provides a method of operating an encoder comprising generating a plurality of multi-scale images having different sizes based on processing unit blocks in source data; calculating feature values for each of the plurality of multi-scale images; calculating a weight corresponding to each of the plurality of multi-scale images based on the resolution of the source data output by a display; calculating complexity for the source data based on the feature values and weights corresponding to each of the plurality of multi-scale images; and generating compressed data for the source data based on the complexity.

An embodiment of the present disclosure provides an image processing device comprising an encoder configured to receive an input image including a plurality of processing unit blocks based on source data, generate a plurality of multi-scale images having different sizes for a first processing unit block among the plurality of processing unit blocks, calculate complexity for the source data based on a feature value corresponding to each of the plurality of multi-scale images and a weight corresponding to each of the plurality of multi-scale images, and generate compressed data for the source data based on the complexity; and a decoder configured to decompress the compressed data and generate output data.

### BRIEF DESCRIPTION OF THE DRAWINGS

FIG. 1 is a drawing illustrating a video coding device including a system on chip according to an example embodiment.

FIG. 2 is a drawing showing the change in size of a processing unit block according to resolution and viewing distance.

FIG. 3 is a drawing illustrating a codec according to an example embodiment.

FIG. 4 is a drawing illustrating an encoder according to an example embodiment.

FIG. 5 is a drawing illustrating an encoder according to an example embodiment.

FIG. 6 is a drawing illustrating an encoder according to an example embodiment.

FIG. 7 is a flowchart illustrating an operation method of an encoder according to an example embodiment.

FIG. 8 is a drawing illustrating an electronic device according to an example embodiment.

### DETAILED DESCRIPTION OF THE EMBODIMENTS

In the following detailed description, only certain embodiments of the present disclosure have been shown and described, simply by way of illustration. As those skilled in the art would realize, the described embodiments may be modified in various different ways, all without departing from the spirit or scope of the present disclosure.

Accordingly, the drawings and description are to be regarded as illustrative in nature and not restrictive. Like reference numerals designate like elements throughout the specification and drawings. In flowcharts described with reference to the drawings, an order of operations may be changed, several operations may be merged, some operations may be divided, and specific operations may not be performed.

In addition, expressions written in the singular may be construed in the singular or plural unless an explicit expression such as “one” or “single” is used. Terms including ordinal numbers such as first, second, and the like will be used only to describe various component and are not to be interpreted as limiting these components. These terms may be used for the purpose of distinguishing one constituent element from other constituent elements.

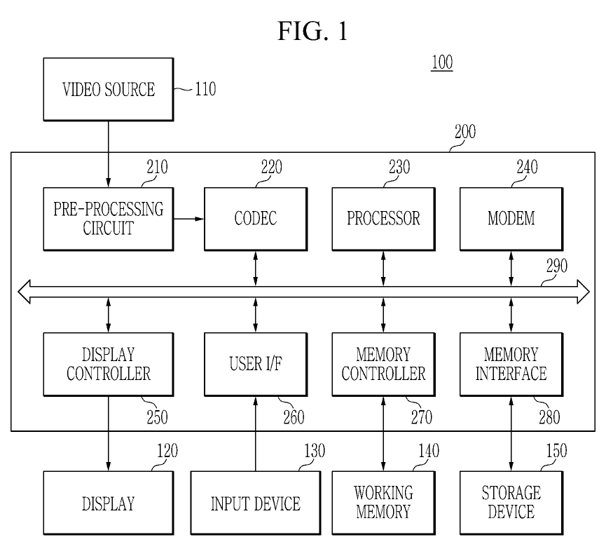

FIG. 1 is a drawing illustrating a video coding device including a system on chip according to an example embodiment.

The video coding device 100 may be a variety of devices capable of processing 2D (dimensional) or 3D graphic data and displaying the processed data. For example, the video coding device 100 may be a TV, a DTV (digital TV), an IPTV (internet protocol TV), a set-top box, a PC (personal computer), a laptop/desktop computer, a computer workstation, a smartphone, a tablet PC, a digital camera, a video game platform (or video game console), a server, etc.

As illustrated in FIG. 1, a video coding device 100 may include a video source 110, an image processing device 200, a display 120, an input device 130, a working memory 140, and a storage device 150.

The video source 110 may be implemented as a camera equipped with a CCD (Charge-Coupled Device) or CMOS (Complementary Metal-Oxide-Semiconductor) image sensor. The video source 110 may generate raw data. A video source 110 may capture a subject and generate video raw data or image raw data. A video source 110 may provide raw data to an image processing device 200.

The image processing device 200 may control the overall operation of the video coding device 100. For example, the image processing device 200 may include a system on chip (SoC), an integrated circuit (IC), a motherboard, an application processor (AP), a mobile AP, etc.

The image processing device 200 may receive raw data from a video source 110. The image processing device 200 may process raw data. In one embodiment, the image processing device 200 may process raw data through several steps, store the processed data, and repeat the process.

In one embodiment, the image processing device 200 may display processed data through the display 120. The image processing device 200 may store processed data in a storage device 150 or transmit processed data to another data processing system.

In one embodiment, data output from a video source 110 may be transmitted to a pre-processing circuit 210 via a MIPI® camera serial interface (CSI).

The image processing device 200 may include a pre-processing circuit 210, a codec 220, a processor 230, a modem 240, a display controller 250, a user interface 260, a memory controller 270, a memory interface 280, and a bus 290.

The codec 220, processor 230, modem 240, display controller 250, user interface 260, and memory interface 280 may transmit and receive data to and from each other through the bus 290. For example, the bus 290 may be implemented as at least one selected from, but is not limited to, a Peripheral Component Interconnect Bus (PCI Bus), a PCI Express (PCIe) bus, an Advanced High Performance Bus (AMBA), an Advanced High Performance Bus (AHB), an Advanced Peripheral Bus (APB), an Advanced eXtensible Interface (AXI) bus, and any combination thereof.

The pre-processing circuit 210 may receive raw data output from the video source 110. The pre-processing circuit 210 may process raw data and convert it into source data. The pre-processing circuit 210 may output source data generated based on the processing result to the codec 220. In one embodiment, the pre-processing circuit 210 may be an image signal processor (ISP). In FIG. 1, the pre-processing circuit 210 is illustrated as being implemented inside the image processing device 200, but the pre-processing circuit 210 may also be implemented outside the image processing device 200.

The codec 220 may perform an encoding (or coding) operation on source data. In one embodiment, the codec 220 may perform a decoding (or decryption) operation on data provided from the processor 230 or stored in the working memory 140. The codec 220 may use encoding/decoding technologies such as JPEG (joint picture expert group), MPEG (motion picture expert groups), MPEG-2, MPEG-4, VC-1, VP9, AV1, H.264, H.265, or HEVC (High Efficiency Video Coding), but the present invention is not limited thereto, and the codec 220 may use any encoding/decoding technology.

The codec 220 may be a hardware codec or a software codec. In the specification, the image processing operation of the codec 220 is described with encoding operations as an example, but the image processing operation may include a decoding operation. For example, the codec 220 may be a multi-format codec (MFC). The codec 220 may perform compression based on the correlation between a plurality of frames within the source data.

The codec 220 may generate a plurality of multi-scale images of different sizes based on the source data, and generate compressed data based on a plurality of multi-scale images. In one embodiment, the codec 220 may determine a plurality of weights corresponding to each of the plurality of multi-scale images based on the resolution of the source data and the viewing distance of the display 120 to a user, and generate compressed data by reflecting the determined weights for each of the plurality of multi-scale images. The codec 220 may store compressed data in working memory 140.

The processor 230 may control the operation of the image processing device 200. The processor may run software (applications, operating systems, device drivers). The processor 230 may execute an operating system (OS) loaded into the working memory 140. The processor 230 may execute various application programs that are driven based on an operating system (OS). The processor 230 may be provided as a homogeneous multi-core processor or a heterogeneous multi-core processor.

The processor 230 may perform computational processing on raw data or source data. In one embodiment, the processor 230 may compress raw data or source data to generate new source data or update source data. The processor 230 may store new source data or updated source data in the working memory 140.

The modem 240 may output data encoded by the codec 220 or processor 230 to the outside using wireless communication technology. In one embodiment, the modem 240 may be configured as a unidirectional communication interface or a bidirectional communication interface. For example, the modem 240 may transmit or receive messages to establish a communication connection. For example, the modem 240 may be configured to identify and exchange any other information related to data transmission, such as a communications link and/or encoded data transmission.

The display controller 250 may transmit data output from the codec 220 or processor 230 to the display 120. For example, the display controller 250 may transmit data to the display 120 via a MIPI display serial interface (DSI).

The user interface 260 may receive an input signal from an input device 130. The user interface 260 may transmit data generated by input operations to the processor 230.

The memory controller 270 may read data stored in the working memory 140 under the control of the codec 220 or processor 230. The memory controller 270 may transmit the read data to the codec 220 or processor 230. Additionally, the memory controller 270 may write data output from the codec 220 or processor 230 into the working memory 140 under the control of the codec 220 or processor 230.

The memory interface 280 may access the storage device 150 based on the request of the processor 230. A memory interface 280 may provide an interface between a system on chip (SoC) and a storage device 150. For example, data processed by the processor 230 may be stored in a storage device 150 through a memory interface 280. For example, data stored in the storage device 150 may be provided to the processor 230 via the memory interface 280.

The display 120 may display source data on the screen. For example, the display 120 may include any type of display, such as an integrated or external display or monitor. For example, the display may include a Liquid Crystal Display (LCD), an Organic Light Emitting Diode (OLED) display, a plasma display, a projector, a micro LED display, a Liquid Crystal on Silicon (LCoS), a Digital Light Processor (DLP), or any other type of display, but the present invention is not limited thereto.

The input device 130 may receive user input from a user and transmit an input signal in response to the user operation to the user interface 260. For example, the input device 130 may be implemented as a touch panel, a touch screen, a voice recognizer, a touch pen, a keyboard, a mouse, a track point, etc., but the present invention is not limited thereto. For example, if the input device 130 is a touch screen, the input device 130 may include a touch panel and a touch panel controller. Additionally, if the input device 130 is a voice recognition device, the input device 130 may include a voice recognition sensor and a voice recognition controller. The input device 130 may be configured to be connected to the display 120, or may be configured separately from the display 120.

The working memory 140 may receive encoded data and/or decoded data from the codec 220. The working memory 140 may store received data. Additionally, the working memory 140 may transmit stored data to the processor 230 or modem 240. In one embodiment, the working memory 140 may be implemented as volatile memory. For example, volatile memory may include random access memory (RAM), static RAM (SRAM), dynamic RAM (DRAM), synchronous DRAM (SDRAM), thyristor RAM (T-RAM), zero capacitor RAM (Z-RAM), or twin transistor RAM (TTRAM).

The storage device 150 may be provided as a storage medium of the video coding device 100. The storage device 150 may store user data, operating system images (OS Images), application programs, etc. In one embodiment, the storage device 150 may be implemented as nonvolatile memory. For example, nonvolatile memory may be implemented as electrically erasable programmable read-only memory (EEPROM), flash memory, magnetic RAM (MRAM), spin-transfer torque MRAM (STM or STT-MRAM), ferroelectric RAM (FeRAM), phase change RAM (PRAM), or resistive RAM (RRAM). Additionally, the nonvolatile memory may be implemented as a multimedia card (MMC), an embedded MMC (eMMC), a universal flash storage (UFS), a solid state drive (solid state disk (SSD)), a USB flash drive, or a hard disk drive (HDD).

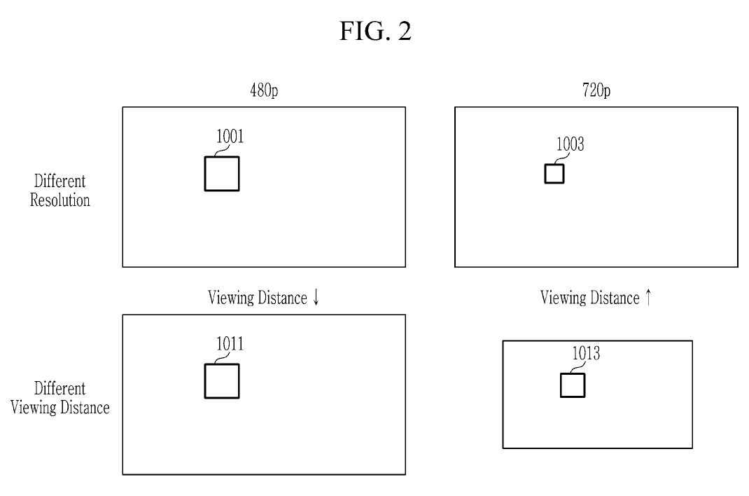

FIG. 2 is a diagram showing the change in size of a processing unit block according to resolution and viewing distance.

In video compression, a single frame may be divided into a plurality of unit blocks to compress and encode the video. For example, video compression methods may include MPEG-1, MPEG-2, MPEG-4, H.264/MPEG-4 AVC (Advanced Video Coding), and HEVC (High-Efficiency Video Coding). In an image compression method, a unit block is encoded, and then the unit block may be encoded based on the bits required to encode the unit block and the degree of distortion between the original unit block and the encoded unit block. As the bitrate required for encoding increases, the degree of distortion decreases, and as the bitrate required for encoding decreases, the degree of distortion may increase. Accordingly, Rate-Distortion Optimization (RDO) method may be used to optimize encoding.

Rate-Distortion Optimization (RDO) is a method that expresses the degree of distortion between an original unit block and an encoded unit block as a cost function using the distortion value and the bitrate of the encoded unit block. The distortion value may be a value representing the degree of distortion between the original unit block and the encoded unit block. To obtain the distortion value, methods such as SAD (Sum of Absolute Difference), SATD (Sum of Absolute Transformed Difference), and SSE (Sum of Squared Error) may be used to obtain the difference between two blocks. In order to obtain the distortion value between the original image and the encoded image, a method may be used, such as calculating the peak signal-to-noise ratio (PSNR) using the mean squared error (MSE), a method applying structural similarity (SSIM), or a multi-scale structural similarity (MS-SSIM) method that applies SSIM by downsizing the target image and the encoded image several times.

Meanwhile, humans may perceive that the size of blocks within the screen becomes relatively smaller as the resolution of the image output from the display (e.g., display 120 in FIG. 1), i.e. the source data, increases. For example, as illustrated in FIG. 2, the size of the first block 1001 perceived by a human on a screen that outputs source data having a resolution of 480p may be larger than the size of the second block 1003 perceived by a human on a screen that outputs source data having a resolution of 720p. Here, the first block 1001 and the second block 1003 may be blocks of the same size. This is because, although the screen size itself is the same, the size of the region perceived by humans changes due to changes in resolution.

Additionally, humans may perceive that the size of blocks within the screen becomes relatively smaller as the viewing distance from the display 120 increases. For example, as illustrated in FIG. 2, when viewing the screen from a first distance (e.g., “Viewing Distance ↓”), the size of the first block 1011 perceived by a human may be larger than the size of the second block 1013 perceived by a human when viewing the screen from a second distance (e.g., “Viewing Distance ↑”).

Therefore, in order to maintain a constant block size that a person visually perceives, it is necessary to adjust the block size by considering the viewing distance or the resolution of the source data to be output to the display.

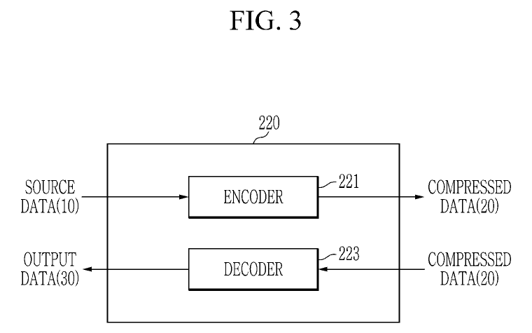

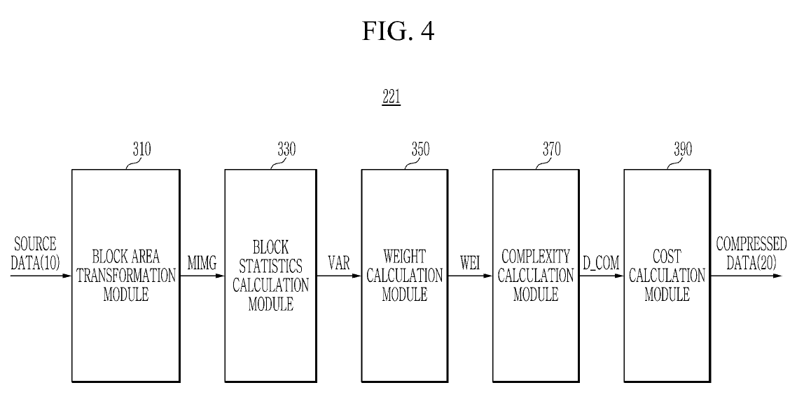

FIG. 3 is a drawing illustrating a codec according to an embodiment. FIG. 4 is a drawing illustrating an encoder according to an example embodiment.

As illustrated in FIG. 3, the codec 220 may include an encoder 221 and a decoder 223.

The encoder 221 may receive source data 10 and generate compressed data 20. In one embodiment, the encoder 221 may receive source data 10 from a pre-processing circuit 210, a processor 230, etc. Compressed data 20 may be transmitted to the working memory 140 via the bus 290 and the memory controller 270.

The decoder 223 may decompress compressed data 20 stored in memory to generate output data 30. Output data 30 may be transmitted to a processor (e.g., display 230 in FIG. 1). Output data 30 may be transmitted to the display 120 via the display controller 250.

The encoder 221 and decoder 223 may each be implemented by various suitable circuits, for example, one or more microprocessors, a digital signal processor (DSP), an application-specific integrated circuit (ASIC), a field-programmable gate array (FPGA), discrete logic, hardware, or any combination thereof. If the present disclosure is partially implemented using software, the device may store software instructions in a suitable non-transitory computer-readable storage medium and execute the software instructions using hardware, such as one or more processors, to perform the technique of the present disclosure. Any of the above (including hardware, software, or a combination of hardware and software) may be considered one or more processors.

Referring to FIG. 4, the encoder 221 may include a block area transformation module 310, a block statistics calculation module 330, a weight calculation module 350, a complexity calculation module 370, and a cost calculation module 390.

The block area transformation module 310 may receive source data 10 as an input image on a frame-by-frame basis. The source data 10 includes at least two frames, and each frame may include a plurality of processing unit blocks arranged in rows and columns. In one embodiment, each of the plurality of processing unit blocks may have a size of 32 * 32. For example, each processing unit block may have a size of 32 pixels by 32 pixels. Meanwhile, the present invention is not limited thereto, and the processing unit block may have any preset size.

A processing unit block may be classified into a target block and a plurality of adjacent blocks. A target block may be a block that is the target of processing within a processing unit block. For example, a target block may have a size of 8 * 8. For example, the target block may have a size of 8 pixels by 8 pixels. A plurality of adjacent blocks may include blocks within the processing unit block, excluding the target block. For example, the plurality of adjacent blocks may include a plurality of blocks positioned adjacent to the target block. Here, the plurality of adjacent blocks may include blocks that are directly adjacent to the target block as well as blocks that are indirectly adjacent to the target block. The plurality of adjacent blocks may be adjacent in one or both of the column direction or the row direction.

In one embodiment, the block area transformation module 310 may generate a plurality of multi-scale images MIMG for each of the plurality of processing unit blocks. Each of the plurality of multi-scale images MIMG may have different sizes. Each of the plurality of multi-scale images MIMG may include a target block. The block area transformation module 310 may transform the scale of an input image at a constant ratio or constant difference. For example, a constant ratio may be 1/2. The block area transformation module 310 may generate a predetermined number of multi-scale images MIMG. For example, the block area transformation module 310 may generate three multi-scale images MIMG, namely, a first multi-scale image, a second multi-scale image, and a third multi-scale image. The size of the first multi-scale image may be larger than the size of the second multi-scale image, and the size of the second multi-scale image may be larger than the size of the third multi-scale image. For example, a first multi-scale image may have a size of 32 * 32 that includes the target block, a second multi-scale image may have a size of 16 * 16 that includes the target block, and a third multi-scale image may have a size of 8 * 8 that includes the target block. For example, the block area transformation module 310 may generate a first multi-scale image having a size of 32 pixels * 32 pixels, generate a second multi-scale image having a size of 16 pixels * 16 pixels, and generate a third multi-scale image having a size of 8 pixels * 8 pixels.

In one embodiment, the block area transformation module 310 may generate a plurality of multi-scale images MIMG using the image pyramid method. An image pyramid may be a multi-scale pyramid representing an image at a plurality of resolution levels or a plurality of scales.

In one embodiment, the block area transformation module 310 may generate a plurality of multi-scale images MIMG by decomposing the input image using a Gaussian pyramid. The block area transformation module 310 may generate a plurality of multi-scale images MIMG by applying a Gaussian mean to each block area of the input image and performing weighted averaging of pixel values with surrounding values. For example, the block area transformation module 310 may generate a plurality of multi-scale images MIMG by applying arbitrary weights to the input image.

In one embodiment, the block area transformation module 310 may generate a plurality of multi-scale images MIMG by decomposing the input image using a Laplacian pyramid. For example, the block area transformation module 310 may generate a plurality of multi-scale images MIMG by multiplying an input image with a set of transformation functions.

Meanwhile, the present invention is not limited thereto, and the block area transformation module 310 may generate a plurality of multi-scale images MIMG using a Steerable pyramid or other types of pyramids in addition to a Gaussian pyramid and a Laplacian pyramid. The block area transformation module 310 may use a subsampling method that selects only some pixels from an input image to generate a plurality of images with different resolution levels in the process of generating a plurality of multi-scale images MIMG using a pyramid, a nearest neighbor interpolation method that generates new pixel values based on surrounding pixel values to generate images at a plurality of scales, etc. In one embodiment, the block area transformation module 310 may generate a plurality of multi-scale images MIMG using various methods, not only the pyramid structure.

The block statistics calculation module 330 may receive a plurality of multi-scale images MIMG from the block area transformation module 310. The block statistics calculation module 330 may calculate feature values for each of a plurality of multi-scale images MIMG. The feature value may be a value indicating a unique characteristic of each of a plurality of multi-scale images MIMG. For example, the feature value could be the variance VAR for each of a plurality of multi-scale images MIMG. In one embodiment, the block statistics calculation module 330 may compute a first variance for a first multi-scale image, a second variance for a second multi-scale image, and a third variance for a third multi-scale image among a plurality of multi-scale images MIMG.

In one embodiment, the block statistics calculation module 330 may include a plurality of variance calculation modules, each of the plurality of variance calculation modules corresponding to a plurality of multi-scale images MIMG. A plurality of variance calculation modules may calculate variances for each of a plurality of multi-scale images MIMG.

For example, a plurality of variance calculation modules may calculate variances for areas of corresponding sizes. Meanwhile, the present invention is not limited thereto, and when the first multi-scale image has a size of 32 * 32, the second multi-scale image has a size of 16 * 16, and the third multi-scale image has a size of 8 * 8, the first variance calculation module corresponding to the first multi-scale image may calculate variance for an area of the first multi-scale image, the second variance calculation module corresponding to the second multi-scale image may calculate variance for an area of the second multi-scale image, and the third variance calculation module corresponding to the third multi-scale image may calculate variance for an area of the third multi-scale image.

In FIG. 4, the block area transformation module 310 and the block statistics calculation module 330 are depicted as separate configurations, but the present invention is not limited thereto, and the block area transformation module 310 and the block statistics calculation module 330 may be implemented as a single configuration. Here, the block statistics calculation module 330 may perform an operation of calculating variance for each of the plurality of multi-scale images while the block area transformation module 310 performs an operation of generating a plurality of multi-scale images using the image pyramid.

The weight calculation module 350 may determine a weight WEI corresponding to each of a plurality of multi-scale images MIMG based on the variance VAR and viewing environment.

In order to maintain a constant size of a block perceived by a human, a weight calculation module 350 may determine a weight WEI corresponding to each of a plurality of multi-scale images MIMG based on the resolution of source data to be output by the display and the human viewing distance. In one embodiment, the weight calculation module 350 may predict the viewing distance based on the type of display 120. For example, the weight calculation module 350 may assume that the viewing distance is short with respect to the size of screen because the screen size of the TV is large when the display 120 is a TV. For example, the weight calculation module 350 may assume that the viewing distance is far with respect to the size of screen because the screen size of the mobile phone is small when the display 120 is a mobile phone.

For example, the weight calculation module 350 may determine that the higher the resolution of the source data to be output by the display 120, the smaller the size of the block perceived by a human. Thus, the weight corresponding to a multi-scale image of a large size among a plurality of multi-scale images MIMG has a larger value than the weight corresponding to a multi-scale image of a small size. In addition, the weight calculation module 350 may determine that the lower the resolution of the source data to be output by the display 120, the larger the size of the block perceived by a human. Thus, the weight corresponding to a multi-scale image of a smaller size among a plurality of multi-scale images MIMG has a larger value than the weight corresponding to a multi-scale image of a larger size.

For example, the weight calculation module 350 may determine that the weight corresponding to a large-sized multi-scale image among a plurality of multi-scale images MIMG has a larger value than the weight corresponding to a small-sized multi-scale image, because the size of the block perceived by a human becomes relatively smaller as the viewing distance from which the display 120 gets farther (e.g., on a mobile phone, etc.). In addition, the weight calculation module 350 may determine that the weight corresponding to a multi-scale image of a smaller size among a plurality of multi-scale images MIMG has a larger value than the weight corresponding to a multi-scale image of a larger size, because the size of a block perceived by a human becomes relatively larger as the viewing distance for viewing the display 120 gets closer (e.g., TV, etc.).

In one embodiment, the weight calculation module 350 may use a machine learning algorithm such as deep learning to determine weight WEI such that the weights corresponding to each of the plurality of multi-scale images MIMG have an optimal ratio. For example, the weight calculation module 350 may determine the optimal weight WEI using a machine learning algorithm learned about the weight WEI that controls the size of a block perceived by a human to be constant based on the resolution of the source data.

For example, the weight calculation module 350 may determine a first weight corresponding to a first multi-scale image, a second weight corresponding to a second multi-scale image, and a third weight corresponding to a third multi-scale image. The weight calculation module 350 may determine the first weight, the second weight, and the third weight in a ratio of 1:2:4 when the source data has a resolution equal to or greater than a preset threshold. For example, the weight calculation module 350 may determine the first weight, the second weight, and the third weight in a ratio of 1:2:4 when the shorter side of the source data, either width or height, has a value of 896 pixels or more. The weight calculation module 350 may determine the first weight, the second weight, and the third weight in a ratio of 4:2:1 when the source data has a resolution lower than full high definition (FHD). The present invention is not limited thereto, and the weight calculation module 350 may determine the first weight, the second weight, and the third weight so that the first weight, the second weight, and the third weight have any ratio.

The complexity calculation module 370 may calculate the complexity D_COM for the source data 10 based on the variance VAR and weight WEI. Complexity D_COM may be a weighted sum in which the weights corresponding to each of a plurality of multi-scale images MIMG are applied to each of the multiple multi-scale images MIMG. In one embodiment, the complexity D_COM may be a temporary quantization parameter for determining the quantization parameter QP. Quantization coefficients may be used to determine the distortion value and bit rate of the encoded unit block during the process of compressing source data 10. For example, as the quantization factor increases, the size of the bitrate (i.e., the amount of data) decreases, but distortion may increase. Also, as the quantization factor decreases, the size of the bitrate (i.e., the amount of data) increases, but distortion may decrease.

In one embodiment, the complexity calculation module 370 may multiply the variance VAR of each of the plurality of multi-scale images by a weight corresponding to each of the plurality of multi-scale images. Thereafter, the weight calculation module 350 may calculate the complexity D_COM by adding the value obtained by multiplying a plurality of multi-scale images and their corresponding weights.

For example, the complexity calculation module 370 may calculate a first value by multiplying a first weight by a first variance corresponding to a first multi-scale image, calculate a second value by multiplying a second weight by a second variance corresponding to a second multi-scale image, and calculate a third value by multiplying a third weight by a third variance corresponding to a third multi-scale image. Thereafter, the complexity calculation module 370 may calculate the complexity D_COM by adding the first value, the second value, and the third value.

The cost calculation module 390 may calculate quantization coefficients based on complexity D_COM.

In one embodiment, the cost calculation module 390 may calculate quantization coefficients based on complexity and image feature data. Image feature data may be data indicating the ratio of high-frequency areas and low-frequency areas within an image of source data 10. For example, image feature data may indicate the ratio of high-frequency regions having a specific frequency. For example, image feature data may be data that indicates the proportion of complex elements within a processing unit block, the proportion of simple elements within a processing unit block, whether an edge is included, etc. The cost calculation module 390 may increase the quantization coefficient if the ratio of complex elements (e.g., the ratio occupied by the high-frequency region) is high. The cost calculation module 390 may reduce the quantization coefficients if the ratio of simple elements (e.g., the ratio occupied by the low-frequency region) is high.

In one embodiment, the cost calculation module 390 may have tables preset for logarithmic operations and exponential function operations required to calculate quantization coefficients. The cost calculation module 390 may perform a lambda operation through a preset formula. The cost calculation module 390 may calculate the Lagrange multiplier used in the cost function of the rate-distortion optimization operation. For example, the Lagrange multipliers may have any form based on complexity. The cost calculation module 390 may determine an optimal mode by generating a cost function using a Lagrange multiplier, a distortion value, and a bit rate, and determining a cost function with the lowest value among the cost functions.

The cost calculation module 390 may encode source data 10 into compressed data 20 based on the optimal mode.

In FIG. 4, the complexity calculation module 370 and the cost calculation module 390 are depicted as separate configurations, but the present invention is not limited thereto, and the complexity calculation module 370 and the cost calculation module 390 may be implemented as a single configuration.

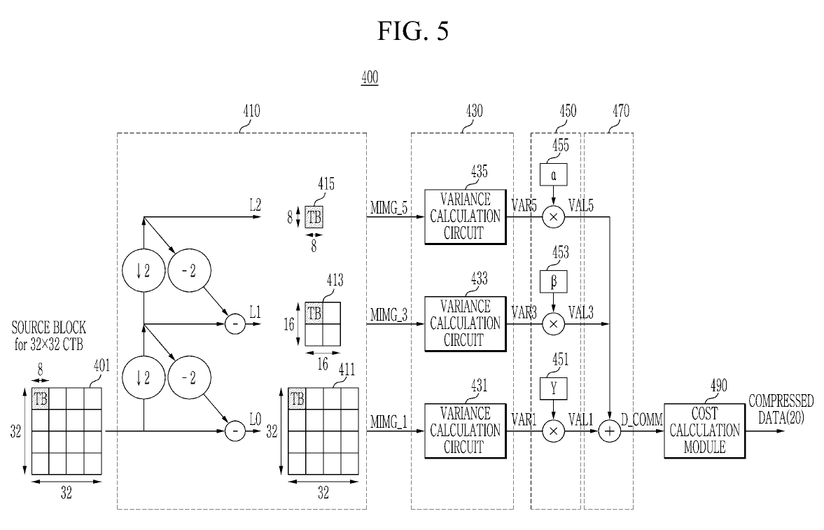

FIG. 5 is a drawing illustrating an encoder according to an example embodiment.

The encoder 400 may include a block area transformation module 410, a block statistics calculation module 430, a weight calculation module 450, a complexity calculation module 470, and a cost calculation module 490. The block area transformation module 410, block statistics calculation module 430, weight calculation module 450, complexity calculation module 470, and cost calculation module 490 of FIG. 5 may correspond to the block area transformation module 310, block statistics calculation module 330, weight calculation module 350, complexity calculation module 370, and cost calculation module 390, respectively, of FIG. 4.

The block area transformation module 410 may receive source data 10 as an input image on a frame-by-frame basis. The input image may include a plurality of processing unit blocks having the size of 32 * 32. Each of the plurality of processing unit blocks may include a target block having a size of 8 * 8. For example, FIG. 5 illustrates an encoder 400 which receives a first processing unit block 401 including a first target block TB.

As illustrated in FIG. 5, the block area transformation module 410 may generate a plurality of multi-scale images MIMG_1, MIMG_3, MIMG_5 corresponding to the first processing unit block using a Laplacian pyramid.

The Laplacian pyramid may be a way to generate a plurality of multi-scale images MIMG_1, MIMG_3, MIMG_5 by extracting high-frequency components by calculating the differences between adjacent levels among a plurality of levels. The block area transformation module 410 may downsample the first processing unit block 401 of the first level L0 to transform it into an image of 16 * 16 size with a lower resolution, and then transform it again to an image of 32 * 32 size, and generate a first multi-scale image 411 by calculating the difference between the transformed image and the first processing unit block 401 of the first level L0. The first multi-scale image 411 includes a target block TB and may have a size of 32 * 32.

Similarly, the block area transformation module 410 may downsample a Gaussian image of the second level L1 to transform it into an image of 8*8 size with a lower resolution, and then transform it again to an image of 16 * 16 size, and generate a second multi-scale image 413 by calculating the difference between the transformed image and the Gaussian image of the second level L1. The second multi-scale image 413 includes a target block TB and may have a size of 16 * 16.

The block area transformation module 410 may downsample a Gaussian image of the second level L1 to generate a Gaussian image of the third level L2 with a lower resolution as a third multi-scale image 415. The third multi-scale image 415 includes a target block TB and may have a size of 8 * 8.

In FIG. 5, the block area transformation module 410 is illustrated as generating a three-level multi-scale image, but the present invention is not limited thereto, and the block area transformation module 410 may generate a multi-scale image having any number of levels.

The Laplacian pyramid method may extract the difference that occurs during the downsampling process and generate a plurality of multi-scale images MIMG_1, MIMG_3, MIMG_5 based on the base image including structural information and the information about the difference. Accordingly, the block area transformation module 410 may generate a more precise plurality of multi-scale images MIMG_1, MIMG_3, MIMG_5 by using the Laplacian image pyramid method, although the amount of computation increases compared to generating a plurality of multi-scale images by using the Gaussian image pyramid method.

The block statistics calculation module 430 may include a plurality of variance calculation circuits 431, 433, 435. Each of the plurality of variance calculation circuits 431, 433, 435 may correspond to each of the plurality of multi-scale images MIMG_1, MIMG_3, MIMG_5. Each of the plurality of variance calculation circuits 431, 433, 435 may calculate the variance in units of blocks of 8 * 8 size within a corresponding multi-scale image.

For example, the first variance calculation circuit 431 may generate a first variance VAR1 by calculating a variance for a block having a size of 8 * 8 including a target block for the first multi-scale image MIMG_1. The second variance calculation circuit 433 may generate a second variance VAR3 by calculating a variance for a block having a size of 8 * 8 including a target block for the second multi-scale image MIMG_3. The third variance calculation circuit 435 may generate a third variance VAR5 by calculating a variance for a block having a size of 8 * 8 including a target block for the third multi-scale image MIMG_5. For example, the block statistics calculation module 430 may calculate the first, second, and third variances VAR1, VAR2, VAR3 based on signals received from corresponding sensors. In one embodiment, to calculate the first variance VAR1, the first variance calculation circuit 431 may acquire a predetermined number N of sensor signal samples from a first sensor over a predetermined time period. The first variance calculation circuit 431 then may calculate a mean value of the N samples. Subsequently, the first variance calculation circuit 431 may calculate the squared difference between each sample and the mean value, and determine the first variance VAR1 by averaging these squared differences. The second variance calculation circuit 433 and the third variance calculation circuit 435 may calculate second and third variances VAR2 and VAR3, respectively, in a similar manner based on signals from second and third sensors, respectively.

The weight calculation module 450 may determine weights corresponding to each of the variances VAR1, VAR3, VAR5 and a plurality of multi-scale images MIMG_1, MIMG_3, MIMG_5. The weight calculation module 450 may determine a first weight 451 corresponding to the first multi-scale image MIMG_1, a second weight 453 corresponding to the second multi-scale image MIMG_3, and a third weight 455 corresponding to the third multi-scale image MIMG_5. In one embodiment, the weight calculation module 450 may determine the first weight 451, the second weight 453, and the third weight 455 based on the resolution of the source data and/or viewing distance. For example, the weight calculation module 450 may determine the first, second, and third weights 451, 453, 455 to ensure perceptual consistency for a human observer. Specifically, the weights are calculated to maintain a substantially constant perceived size of an image block or feature, regardless of variations in source data resolution and/or viewing distance. The weight calculation module 450 may determine these weights based on at least one of a resolution of the source data and an estimated viewing distance to the display.

For example, the weight calculation module 450 may determine the weights by a predefined mathematical function that takes the resolution and/or the viewing distance as input parameters. For example, the weight calculation module 450 may retrieve the weights from a lookup table (LUT) stored in a memory. The weight calculation module 450 may use the resolution and/or the viewing distance values to index the LUT and obtain the corresponding pre-calculated weight values. For example, the weight calculation module 450 may determine the weights adaptively by a machine learning model (e.g., a neural network) that has been trained to output optimal weights for given viewing conditions to achieve perceptual consistency.

For example, the weight calculation module 450 may determine the first weight 451, the second weight 453, and the third weight 455 so that the first weight 451 corresponding to the first multi-scale image MIMG_1 has a larger value than the second weight 453 and the third weight 455 when the resolution of the source data is below a preset threshold. For example, the weight calculation module 450 may determine the values of the first weight 451, the second weight 453, and the third weight 455 such that the ratio of the first weight 451 to the second weight 453 to the third weight 455 is 4:2:1.

Likewise, for example, the weight calculation module 450 may determine the first weight 451, the second weight 453, and the third weight 455 so that the third weight 455 corresponding to the third multi-scale image MIMG_5 has a larger value than the first weight 451 and the second weight 453 when the resolution of the source data is above a preset threshold. For example, the weight calculation module 450 may determine the values of the first weight 451, the second weight 453, and the third weight 455 such that the ratio of the first weight 451 to the second weight 453 to the third weight 455 is 1:2:4.

For example, the weight calculation module 450 may determine the first weight 451, the second weight 453, and the third weight 455 such that the third weight 455 corresponding to the third multi-scale image MIMG_5 has a larger value than the first weight 451 and the second weight 453 when the viewing distance is greater than a preset threshold (for example, the farther away). For example, the weight calculation module 450 may determine the values of the first weight 451, the second weight 453, and the third weight 455 such that the ratio of the first weight 451 to the second weight 453 to the third weight 455 is 1:2:4.

Likewise, for example, the weight calculation module 450 may determine the first weight 451, the second weight 453, and the third weight 455 such that the first weight 451 corresponding to the first multi-scale image MIMG_1 has a larger value than the second weight 453 and the third weight 455 when the viewing distance is less than a preset threshold (e.g., gets closer). For example, the weight calculation module 450 may determine the values of the first weight 451, the second weight 453, and the third weight 455 such that the ratio of the first weight 451 to the second weight 453 to the third weight 455 is 4:2:1.

The complexity calculation module 470 may calculate the complexity D_COM based on the variances VAR1, VAR3, VAR5 and weights 451, 453, 455 corresponding to each of a plurality of multi-scale images MIMG_1, MIMG_3, MIMG_5.

For example, the complexity calculation module 470 may calculate a first value VAL1 by multiplying a first variance VAR1 corresponding to a first multi-scale image MIMG_1 by a first weight 451 (e.g., Y), calculate a second value VAL3 by multiplying a second variance VAR3 corresponding to a second multi-scale image MIMG_3 by a second weight 453 (e.g., β), and calculate a third value VAL5 by multiplying a third variance VAR5 corresponding to a third multi-scale image MIMG_5 by a third weight 455 (e.g., α). Thereafter, the complexity calculation module 370 may calculate the complexity D_COM by adding the first value VAL1, the second value VAL3, and the third value VAL5.

The cost calculation module 490 may calculate quantization coefficients based on complexity D_COM. In one embodiment, the cost calculation module 490 may calculate quantization coefficients based on complexity and image feature data. Thereafter, the cost calculation module 490 may encode the source data 10 into compressed data 20 based on the quantization coefficients.

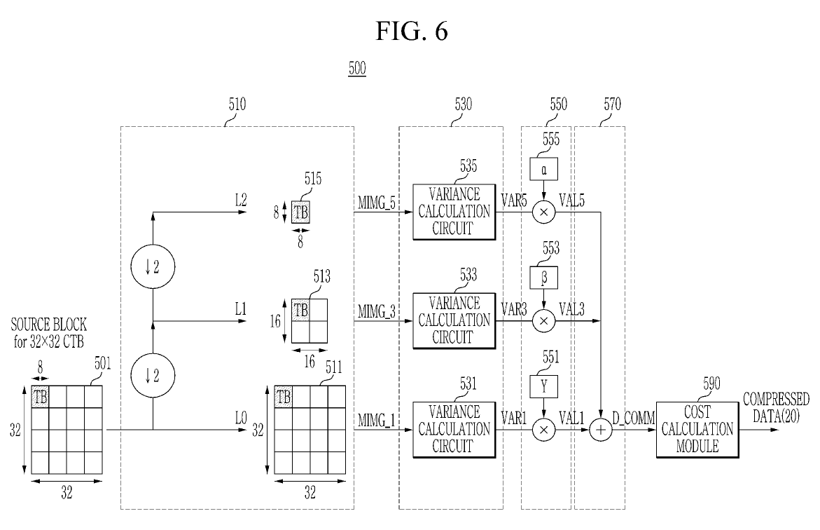

FIG. 6 is a drawing illustrating an encoder according to an example embodiment.

The encoder 500 may include a block area transformation module 510, a block statistics calculation module 530, a weight calculation module 550, a complexity calculation module 570, and a cost calculation module 590.

The block area transformation module 510 may receive source data 10 as an input image on a frame-by-frame basis. The input image may include a plurality of processing unit blocks having the size of 32 * 32. Each of the plurality of processing unit blocks may include a target block having a size of 8 * 8. FIG. 6 illustrates that an encoder 500 which receives a first processing unit block 501 including a first target block TB.

As illustrated in FIG. 6, the block area transformation module 510 may generate a plurality of multi-scale images MIMG_1, MIMG_3, MIMG_5 corresponding to the first processing unit block using a Gaussian pyramid.

Gaussian pyramids may be a way to generate a plurality of multi-scale images MIMG_1, MIMG_3, MIMG_5 by gradually reducing the original image to a lower-resolution version. The block area transformation module 510 may generate the first processing unit block 501 of the first level L0 as a first multi-scale image 511. The block area transformation module 510 may generate a second multi-scale image 513 of the second level L1 by applying a Gaussian blur filter to the first multi-scale image 511 and then reducing the resolution by half. Thereafter, the block area transformation module 510 may generate a third multi-scale image 515 of the third level L2 by applying a Gaussian blur filter to the second multi-scale image 513 and then reducing the resolution by half.

In FIG. 6, the block area transformation module 510 is illustrated as generating a three-level multi-scale image, but the present invention is not limited thereto, and the block area transformation module 510 may generate a multi-scale image having any number of levels.

The Gaussian pyramid method may generate a plurality of multi-scale images MIMG_1, MIMG_3, MIMG_5 by reducing the size of the image while maintaining information about the structural image during the downsampling process. Accordingly, the Gaussian pyramid method may be used in various fields such as image analysis, object detection, and image compression.

Unless otherwise stated, the description of the block statistics calculation module 430, weight calculation module 450, complexity calculation module 470, and cost calculation module 490 described with reference to FIG. 5 may also be applied to the block statistics calculation module 530, weight calculation module 550, complexity calculation module 570, and cost calculation module 590, respectively, of FIG. 6.

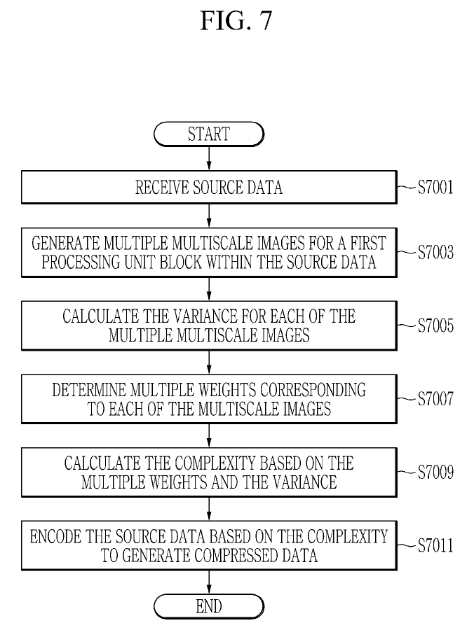

FIG. 7 is a flowchart illustrating an operation method of an encoder according to an example embodiment.

First, the encoder 221 receives source data 10 (S7001).

The encoder 221 generates a plurality of multi-scale images MIMG for the first processing unit block in the source data 10 (S7003).

In one embodiment, the source data 10 may include at least two frames. Each frame may include a plurality of processing unit blocks arranged in rows and columns. The block area transformation module 310 may generate a plurality of multi-scale images MIMG for each of a plurality of processing unit blocks.

In one embodiment, the block area transformation module 310 may generate a plurality of multi-scale images MIMG using an image pyramid method. For example, the block area transformation module 310 may generate a plurality of multi-scale images MIMG using a Gaussian pyramid and/or a Laplacian pyramid.

The encoder 221 calculates the variance for each of a plurality of multi-scale images MIMG (S7005).

The block statistics calculation module 330 may calculate variance corresponding to each of a plurality of multi-scale images MIMG. In one embodiment, the block statistics calculation module 330 may calculate the variance for any equally sized area within a plurality of multi-scale images MIMG.

The encoder 221 determines a plurality of weights WEI corresponding to each of a plurality of multi-scale images MIMG (S7007).

The weight calculation module 350 may determine a weight WEI corresponding to each of a plurality of multi-scale images MIMG based on the resolution of the source data and the viewing distance of a person.

In one embodiment, the weight calculation module 350 may determine that, as the resolution of the source data output by the display 120 increases or the viewing distance increases, the weight corresponding to a multi-scale image of a larger size among a plurality of multi-scale images MIMG has a larger value than the weight corresponding to a multi-scale image of a smaller size. The weight calculation module 350 may determine that, as the resolution of the source data output by the display 120 decreases or the viewing distance decreases, the weight corresponding to a multi-scale image of a smaller size among a plurality of multi-scale images MIMG has a larger value than the weight corresponding to a multi-scale image of a larger size.

The encoder 221 calculates the complexity D_COM based on the variance and weight WEI (S7009).

The complexity calculation module 370 may calculate the complexity D_COM for the source data 10 based on the variance VAR and weight WEI.

In one embodiment, the complexity calculation module 370 may calculate the complexity D_COM by multiplying the variance VAR of each of the plurality of multi-scale images MIMG by a weight WEI corresponding to each of the plurality of multi-scale images MIMG and adding the multiplied value.

The encoder 221 generates compressed data by encoding source data 10 based on complexity D_COM (S7011).

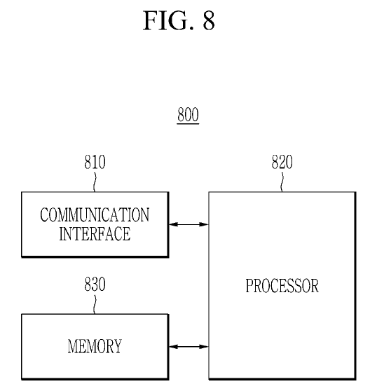

FIG. 8 is a drawing illustrating an electronic device according to an example embodiment.

Referring to FIG. 8, an electronic device 800 according to one embodiment may include a communication interface 810, a processor 820, and a memory 830. However, this is only an example, and the electronic device 800 may additionally include other components. For example, the electronic device 800 may include a plurality of processors.

A communication interface 810 according to one embodiment may provide an interface for communicating with another device (e.g., a server). For example, the communication interface 810 may be configured to transmit or receive signals or data with another device via wired or wireless means. The communication interface 810 may perform communication using various communication methods such as existing known WiFi, LTE, LTE-A, CDMA, OFDM (Orthogonal Frequency Division Multiplexing), COFDM (Coded OFDM), etc., and the communication methods available to the communication interface 810 are not necessarily limited thereto.

In one embodiment, the communication interface 810 may request additional information or image data from the server. Additionally, the communication interface 810 may receive additional information or media from the server.

The processor 820 may be connected to the communication interface 810. The processor 820 may control the overall operations of the electronic device 800. A processor 820 according to one embodiment may control the electronic device 800 as a whole to execute one or more programs stored in a memory 830 to perform the image processing operations (e.g., encoding operations) described above with reference to FIGS. 1 to 7.

In one embodiment, the processor 820 may generate a plurality of multi-scale images based on the received input images, and determine a weight for each of the plurality of multi-scale images based on the resolution of source data including the plurality of input images and the viewing distance of the display, thereby determining an influence of each of the plurality of multi-scale images in generating compressed data. Accordingly, the processor 820 may allocate quantization coefficients considering a wider area of the image as the resolution of the input image increases and/or the viewing distance increases, and may allocate quantization coefficients considering a smaller area of the image as the resolution of the input image decreases and/or the viewing distance decreases. Additionally, the processor 820 may assign quantization coefficients considering a small area to areas within an image that include simple elements for precise compression to areas, and may assign quantization coefficients considering a large area to areas within an image that include complex elements.

The memory 830 according to one embodiment may store various data for driving and controlling the electronic device 800. For example, the memory 830 may store data on optimal weights for each of a plurality of multi-scale images depending on the resolution and viewing distance, data required to generate a plurality of multi-scale images (e.g., data required to apply an image pyramid), data required to calculate quantization coefficients, etc. A program stored in memory 830 may include one or more instructions. A program (one or more instructions) or application stored in memory 830 may be executed by the processor 820.

Although the embodiments of the present disclosure have been described in detail above, the scope of the present disclosure is not limited thereto, and various modifications and improvements made by those skilled in the art using the basic concept of the present disclosure defined in the following claims also fall within the scope of the present disclosure.

What is claimed is:

1. An encoder comprising:
a block area transformation module configured to receive a processing unit block that is generated based on source data and includes a target block, and generate a plurality of multi-scale images having different sizes based on the processing unit block, each of the plurality of multi-scale images including the target block;
a statistic calculation module configured to calculate feature values for each of the plurality of multi-scale images;
a weight calculation module configured to calculate a weight corresponding to each of the plurality of multi-scale images based on a resolution of the source data output by a display;
a complexity calculation module configured to calculate complexity for the source data based on the feature values and the weights corresponding to each of the plurality of multi-scale images; and
a cost calculation module configured to generate compressed data for the source data based on the complexity.

2. The encoder of claim 1, wherein the block area transformation module is configured to generate the plurality of multi-scale images by downsampling the processing unit block using at least one of a Laplacian pyramid and a Gaussian pyramid.

3. The encoder of claim 1,
wherein the plurality of multi-scale images includes a first multi-scale image, a second multi-scale image, and a third multi-scale image, wherein a size of the first multi-scale image is larger than a size of the second multi-scale image, and a size of the second multi-scale image is larger than a size of the third multi-scale image, and
wherein the weight calculation module is configured to calculate a first weight corresponding to the first multi-scale image, a second weight corresponding to the second multi-scale image, and a third weight corresponding to the third multi-scale image.

4. The encoder of claim 3, wherein the weight calculation module is configured to determine that the third weight is greater than the second weight and that the second weight is greater than the first weight based on the resolution being equal to or greater than a preset threshold.

5. The encoder of claim 4, wherein a ratio of the first weight, the second weight, and the third weight is 1:2:4.

6. The encoder of claim 3, wherein the weight calculation module is configured to determine that the first weight is greater than the second weight and the second weight is greater than the third weight based on the resolution being less than a preset threshold.

7. The encoder of claim 6, wherein a ratio of the first weight, the second weight, and the third weight is 4:2:1.

8. The encoder of claim 3, wherein the weight calculation module is configured to calculate a weight using a machine learning algorithm.

9. The encoder of claim 3, wherein the weight calculation module is configured to calculate a weight corresponding to each of the plurality of multi-scale images based on a viewing distance of the display, and determine that the third weight is greater than the second weight and the second weight is greater than the first weight based on the viewing distance being equal to or greater than a preset threshold.

10. The encoder of claim 9, wherein the weight calculation module is configured to determine that the first weight is greater than the second weight and that the second weight is greater than the third weight based on the viewing distance being less than the preset threshold.

11. The encoder of claim 1, wherein the cost calculation module is configured to generate the compressed data for the source data based on image feature data, which is data indicating a ratio of high-frequency areas and low-frequency areas within the source data.

12. A method of operating an encoder comprising:
generating a plurality of multi-scale images having different sizes based on processing unit blocks in source data;
calculating feature values for each of the plurality of multi-scale images;
calculating a weight corresponding to each of the plurality of multi-scale images based on a resolution of the source data output by a display;
calculating complexity for the source data based on the feature values and weights corresponding to each of the plurality of multi-scale images; and
generating compressed data for the source data based on the complexity.

13. The method of operating the encoder of claim 12, wherein the generating the plurality of multi-scale images comprises generating the plurality of multi-scale images by downsampling the processing unit blocks using at least one of a Laplacian pyramid and a Gaussian pyramid.

14. The method of operating the encoder of claim 12, wherein the calculating the weight comprises:
calculating a first weight corresponding to a first multi-scale image among the plurality of multi-scale images, a second weight corresponding to a second multi-scale image among the plurality of multi-scale images, the second multi-scale image having a smaller size than the first multi-scale image, and a third weight corresponding to a third multi-scale image among the plurality of multi-scale images, the third multi-scale image having a smaller size than the second multi-scale image;
determining that the third weight is greater than the second weight and that the second weight is greater than the first weight based on the resolution being greater than or equal to a preset threshold; and
determining that the first weight is greater than the second weight and that the second weight is greater than the third weight based on the resolution being less than the preset threshold.

15. The method of operating an encoder of claim 12, wherein calculating the weight comprises:
calculating a first weight corresponding to a first multi-scale image among the plurality of multi-scale images, a second weight corresponding to a second multi-scale image among the plurality of multi-scale images, and a third weight corresponding to a third multi-scale image among the plurality of multi-scale images;
determining that the third weight is greater than the second weight and the second weight is greater than the first weight based on a viewing distance of the display being greater than a preset threshold; and
determining that the first weight is greater than the second weight and that the second weight is greater than the third weight based on the viewing distance being less than the preset threshold.

16. An image processing device comprising:
an encoder configured to receive an input image including a plurality of processing unit blocks based on source data, generate a plurality of multi-scale images having different sizes for a first processing unit block among the plurality of processing unit blocks, calculate complexity for the source data based on a feature value corresponding to each of the plurality of multi-scale images and a weight corresponding to each of the plurality of multi-scale images, and generate compressed data for the source data based on the complexity; and
a decoder configured to decompress the compressed data and generate output data.

17. The image processing device of claim 16, further comprising:
a display controller configured to receive the output data and output the output data to a display.

18. The image processing device of claim 17, wherein the weight corresponding to each of the plurality of multi-scale images is determined based on a resolution of the output data output by the display and a viewing distance of the display.

19. The image processing device of claim 18,
wherein the plurality of multi-scale images includes a first multi-scale image, a second multi-scale image, and a third multi-scale image, wherein a size of the first multi-scale image is larger than a size of the second multi-scale image, and a size of the second multi-scale image is larger than a size of the third multi-scale image,
wherein a third weight corresponding to the third multi-scale image is greater than a second weight corresponding to the second multi-scale image and the second weight is greater than a first weight corresponding to the first multi-scale image based on the resolution being equal to or greater than a preset threshold,
wherein the first weight is greater than the second weight, and the second weight is greater than the third weight based on the resolution being less than the preset threshold.

20. The image processing device of claim 18,
wherein the plurality of multi-scale images includes a first multi-scale image, a second multi-scale image, and a third multi-scale image, wherein a size of the first multi-scale image is larger than a size of the second multi-scale image, and a size of the second multi-scale image is larger than a size of the third multi-scale image,
wherein a first weight corresponding to the first multi-scale image is greater than a second weight corresponding to the second multi-scale image, and the second weight is greater than a third weight corresponding to the third multi-scale image based on a viewing distance being less than a preset threshold,
wherein the third weight is greater than the second weight, and the second weight is greater than the first weight based on the viewing distance being equal to or greater than the preset threshold.
